(19) United States
(12) Patent Application Publication
(10) Pub. No.: US 2024/0104627 A1
(43) Pub. Date: Mar. 28, 2024

(54) CONTEXTUAL BASED RECOMMENDATIONS SYSTEMS AND METHODS

(71) Applicant: Grubbrr SPV LLC, Boca Raton, FL (US)

(72) Inventors: Bhavin Asher, Boca Raton, FL (US); Alfred Ajay Aureate Rajakumar, Cupertino, CA (US); Smit Patel, Boca Raton, FL (US)

(21) Appl. No.: 17/950,249

(22) Filed: Sep. 22, 2022

(51) Int. Cl. G06Q 30/06

(52) U.S. Cl. CPC G06Q 30/0631; G06Q 30/0635

(57) ABSTRACT

Systems and methods for providing recommendations. Input is received that indicates that an entity has selected a first item for purchase. A nodal model is utilized to determine a weighted likelihood that the entity may purchase a second item based on the entity selecting the first item. The weighted likelihood and communication medium is employed to select a format for providing a recommendation to the entity for purchase of the second item. The recommendation is encoded within a message in the format. The message is transmitted to the entity.

### BACKGROUND OF THE INVENTION

When merchants sell products to consumers, both entities find it valuable if the merchant is able to efficiently provide accurate product recommendations to the consumer at the time of sale. The consumer may use the recommendation to purchase an additional product. For example, the consumer may purchase an accessory for the original product that the consumer may not have known existed or was a worthwhile supplement to the original product. The consumer benefits because the consumer's purchase is more accurate and efficient. The consumer also benefits because enjoyment of the product is enhanced, and the merchant benefits due to the addition of another sale to the transaction.

A problem exists, however, in that consumers do not always appreciate recommendations that are relevant to them. This is exemplified by automated checkout systems, such as those found at kiosks or marketplace stalls that provide a plethora of recommendations that are frequently relevant to the consumer. Consumers grow tired of receiving these recommendations and often avoid the checkout process because it is a burden. Accordingly, product based recommendation systems and methods that efficiently and accurately present recommendations in a manner that is easy to understand and consistent with the user's implicit preferences.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

In one embodiment a method is provided. Input is received indicating that an entity has selected a first item. A nodal model is used to determine a weighted likelihood that the entity may have interest in a second item based on the entity selecting the first item. The weighted likelihood and a communication characteristic of the entity is used to select a format for providing a recommendation to the entity for purchase of the second item. The recommendation is preferably encoded within a message in the format. The message is transmitted to the entity.

In one embodiment, a system is provided. They system includes a memory and at least one module stored in the memory. The module is preferably configured to receive input indicating that an entity has selected a first item for purchase. A nodal model is utilized to determine a weighted likelihood that the entity may purchase a second item based on the entity selecting the first item. The weighted likelihood and a communication characteristic of the entity is used to select a format for providing a recommendation to the entity for purchase of the second item. The recommendation is encoded within a message in the format. The message is transmitted to the entity.

In one embodiment, a method is provided. A nodal model is built that includes a plurality of nodes and edges, wherein the nodes each represent an item, and the edges each represent the likelihood that an entity may select a second item based on the entity selecting a first item. Input is received from an entity indicating selection of the first item. A communication device is identified to send a message to the entity that contains a recommendation for selecting the second item. The recommendation is preferably encoded within a message that is optimized for the communication device. The message is transmitted to the entity.

### BRIEF DESCRIPTION OF THE DRAWINGS

A more detailed understanding may be had from the following description, given by way of example in conjunction with the accompanying drawings wherein:

FIG. 1 illustrates an aspect of a system including an item recommendation engine module of the present invention;

FIG. 2 illustrates a model utilized by the item recommendation engine module of the present invention;

FIG. 3 illustrates an exemplary process utilized by the item recommendation engine module of the present invention; and

FIG. 4 is an exemplary block diagram representing a computer system in which aspects of the processes and systems disclosed herein or portions thereof may be incorporated.

### DETAILED DESCRIPTION

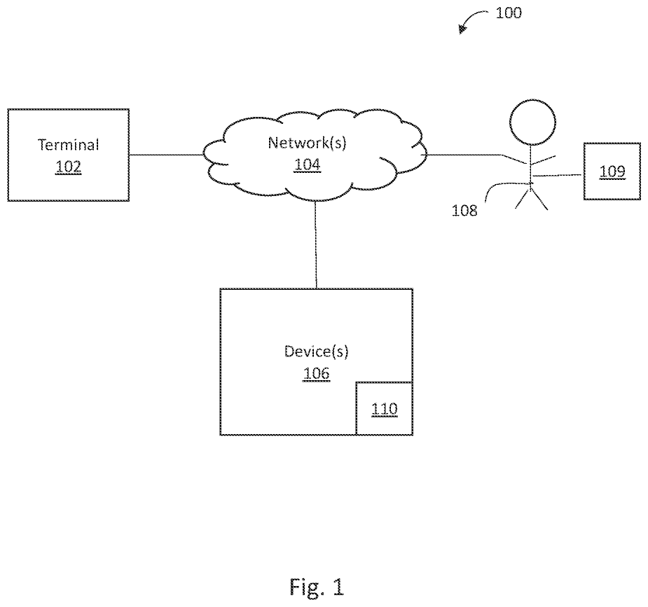

Referring to FIG. 1, a system 100 utilizing a product based recommendation system of the presentation application is provided for illustrative purposes. It should be noted at the outset that the configuration of system 100 is provided for illustrative purposes. Implementation of system 100, including the physical and hardware environment, may vary without departing from the scope of this disclosure.

In one example, system 100 includes a terminal 102, which allows a user or operator to interact with system 100 and may include one or more input/output devices, such as touchscreens, keypads, and the like. System 100 may be included in a kiosk environment that allows a user to purchase items as part of a self-service environment. Accordingly, system 100 may include one or more hardware components that dispense items to a user. In another example, system 100 may be part of a point-of-sale system that is operated by merchant personnel, but that allows a customer to perform certain functions, such as payment or product selection. The particular type of environment may vary depending on the particular application(s). However, examples include product kiosks, lockers, checkout environments for grocers, restaurants, and the like. In addition, the environments in which system 100 operates may be remote from where product fulfillment takes place.

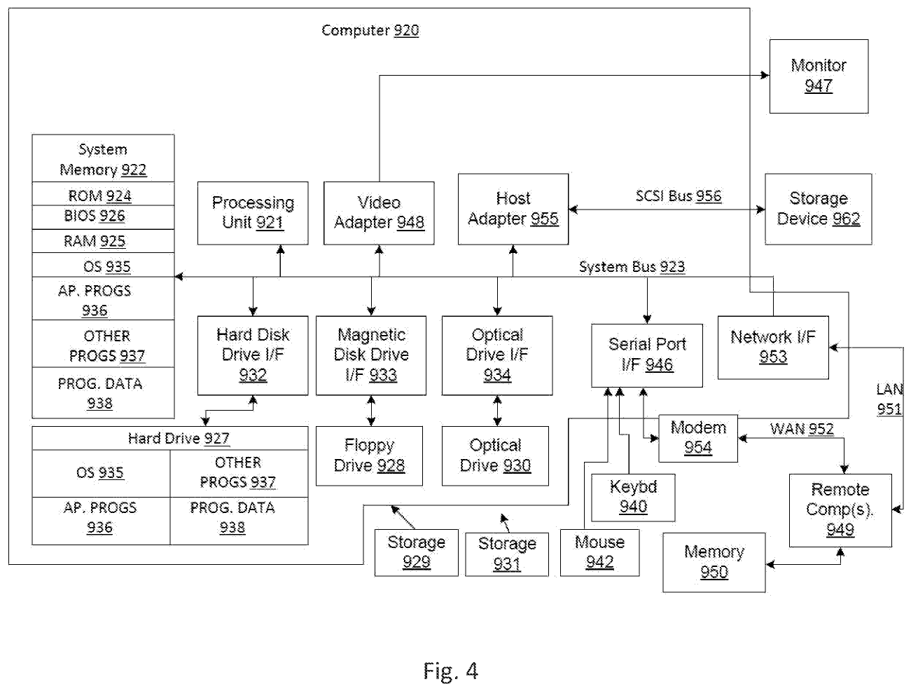

Terminal 102 in one example may be connected through one or more networks 104. Terminal 102 may communicate with one or more other devices 106 through such network(s) 104. Device(s) 106 may include other terminals or computing devices utilized to implement the principles described herein. An exemplary description of a device that may be utilized to implement terminal 102 or devices 106 is provided in connection with FIG. 4.

When a user 108 interacts with terminal 102, the user 108 may make a selection. The selection may be of a product or service that the user 108 may want to purchase, lease, procure, or otherwise consume. The user 109 may select the product or service by interacting with terminal 102. The user 108 may complete the purchase of the product or service at the terminal 102 by submitting payment. Fulfillment of the purchase may take place at the terminal 102 or at another place or time. For instance, an item may be delivered to the customer at home, or the item may be picked up by the user at a different location. In one embodiment, user 108 may interact with terminal 102 through a network 104 and/or another device 109 such as a computer or mobile device (exemplary description provided in connection with FIG. 4).

In one embodiment, during the previously described process, a recommendation engine module 110 may be invoked. The recommendation engine module 110 may execute on terminal 102 or on one or more devices 106. Recommendation engine module 110 provides a product or service-based recommendation to the user 108 based on the product or service selection that the user 108 made in the preceding process. In one embodiment, a recommendation may be provided at the time of selection. In one embodiment, a recommendation may be provided after payment. In one embodiment, a recommendation may be provided at fulfillment. The recommendation may be provided in one form of media or as a multimedia presentation. In one embodiment, the recommendation engine module 110 may provide one recommendation to a user 108. In one embodiment, recommendation engine module 110 may provide a plurality of recommendations to a user 108. In one embodiment, a recommendation may be provided to user 108 based on a level of confidence being achieved that the recommendation is sufficiently relevant to the user 108 based on the user's 109 prior selection or purchase of a product or service.

In one embodiment, the level of confidence is measured through creation of a model in which a plurality of products and/or services are weighted with respect to each other as will be discussed further herein. In one embodiment, the recommendation engine module analyzes the technical environment presented by the user in light of the level of confidence and determines the most efficient technological means to provide the recommendation to the user. For instance, if the user is using a mobile device, then the recommendation engine module 110 may determine if the level of confidence is sufficiently high to provide a recommendation directly to the mobile device, through near field technological means, such as Bluetooth, or through an SMS message.

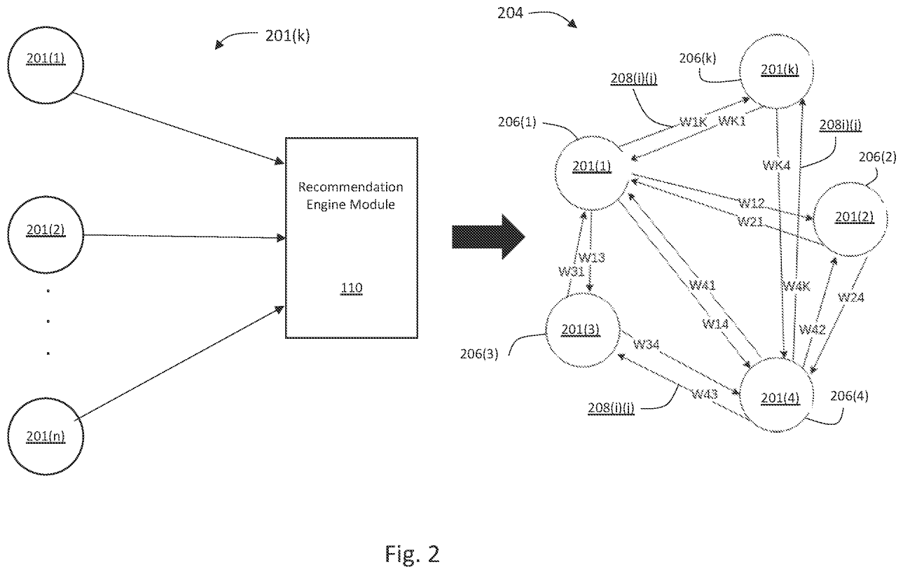

Referring to FIG. 2, a plurality of items 201(k) (where k=1 . . . n) are shown for illustrative purposes. The term “item” is used for illustrative purposes only. An item 201(k) may be a product, service, or thing. An item 201(k) is generally something that a user 108 of system 102 may select. For instance, an item 201(k) may be selected as part of a sales transaction. Nevertheless, the present disclosure is not limited to sales transactions. An item 201(k) may be part of some other type of distributive process. In addition, a user 108 does not necessarily need to be the entity selecting an item 201(k). An item 201(k) could be selected by system 102 or some other entity. For example, an item 201(k) could be selected as part of a product recommendation service, which could be automated or not automated. Also, selection of an item 201(k) could be a preliminary step of a sales process, such as placing an item 201(k) in a shopping cart. Alternatively, selection of an item 201(k) could constitute a sale or exchange that is completed.

Referring further to FIG. 2, data identifying the items 201(k) is provided to Recommendation engine module 110. Recommendation engine module 110 processes the data identifying items 201(k) and in one embodiment creates a nodal model 204 based on items 201(k). The nodal model 204 comprises a plurality of nodes 206(k)(where k=1 . . . n) that correspond to items 201(k). For example, node 206(1) corresponds to item 201(1). Node 206(2) corresponds to item 201(2). Node 206(k) corresponds to item 201(k). The number of items 201(k) and thus the number of nodes 206(k) may depend on a number of factors. For instance, the number of nodes 206(k) may expand or contract in direct proportion to the number of items in an inventory. For instance, if the number of items 201 is f, the number of nodes 206 may be f. If the number of items is f+g, then the number of nodes may expand to f+g and vice versa. In another embodiment the number of nodes 206(k) may expand or contract dynamically based on the interest level for items. For instance, the total number of items may equal f but a dynamic analysis of consumer demand (e.g. based on sales history) may indicate that only f−g items are currently of interest to consumers. In such an instance, the number of nodes may contract to 206(f−g). In another example, the number of items may equal f, but a dynamic analysis of consumer demand (e.g. customer relationship management data) may indicate that there is demand for more items than are in inventory. In such an instance, the nodes 206(k) may equal f+g (where g is the number of additional items). Such recommendations could be provided and system 100 could be configured to fulfill such items if it were possible from a manufacturing or procurement perspective.

In one embodiment, nodes 206(k) are connected by edges 208(i)(j) (where i=1.k and j=1 . . . k). In one embodiment, each of the nodes 206(k) are interconnected with each other by two edges 208(i)(j). For example, nodes 206(1) and item 206(k) are connected to each other through edge 208(1)(k) and 208(k)(1). Nodes 206(2) and item 206(3) are connected by edge 208(2)(3) and edge 208(3)(2). Nodes 206(4) and 206(k) are connected through edge 208(4)(k) and edge 208(k)(4).

In one embodiment, an edge 208 (i)(j) represents the weight Wᵢⱼ given to a recommendation of one item 206(j) given the selection of another item 206(i). For instance, a user 108 may select an item 201(1) for purchase. The edges 208(1)(2) . . . 208(1)(k) represent the weighted likelihood that a user 108 may purchase other products 201(2) . . . 201(k) based on the prior selection of item 201(1). For example, edge 208(1)(2) represents the weight Wiz that a user would select item 201(2) given the selection of item 201(1). Edge 208(1)(3) represents the weight W₁₃ that a user 108 would select item 201(3) given the selection of item 201(1). Edge 208(1)(4) represents the weight W₁₄ that a user would select item 201(4) given the selection of item 201(1). Similarly, edge 208(2)(1) represents the weight W₂₁ that a user would select item 201(1) given the selection of item 201(2). Edge 208(3)(1) represents the weight W₃₁ that a user 108 would select item 201(1) given the selection of item 201(3). Edge 208(4)(1) represents the weight W₄₁ that a user would select item 201(1) given the selection of item 201(4).

The calculation of weights Wᵢⱼ may be calculated and may evolve based on various criteria. The calculation may be based on each individual entity's purchase history or on the purchase history of multiple entities. For instance, if sales data indicates that two products 201(i) and 201(j) are often purchased together, then weights Wᵢⱼ and may have a higher value than weights for products that are not often purchased together. In another example, if a product 201(i) is often purchased after a recommendation triggered by selecting another product 201(j), then weight may be higher than weights for other products, which have not been purchased as frequently after recommendations. In one embodiment, weighting W may be calculated by using an index value. The index may be a numerical value. The higher the value, the greater the weight of a recommendation. For example, every time two items 201(i) and 201(j) are purchased together, Wᵢⱼ and Wⱼᵢ could be indexed by a certain amount, such as +1. If an item 201(i) was selected and item 201(j) was recommended and selected, then weight Wᵢⱼ could be indexed by a greater amount, such as +3. If in similar circumstance, item 201(i) was selected and item 201(j) was recommended and not selected then weight Wᵢⱼ may be decreased by a certain amount, such as −3.

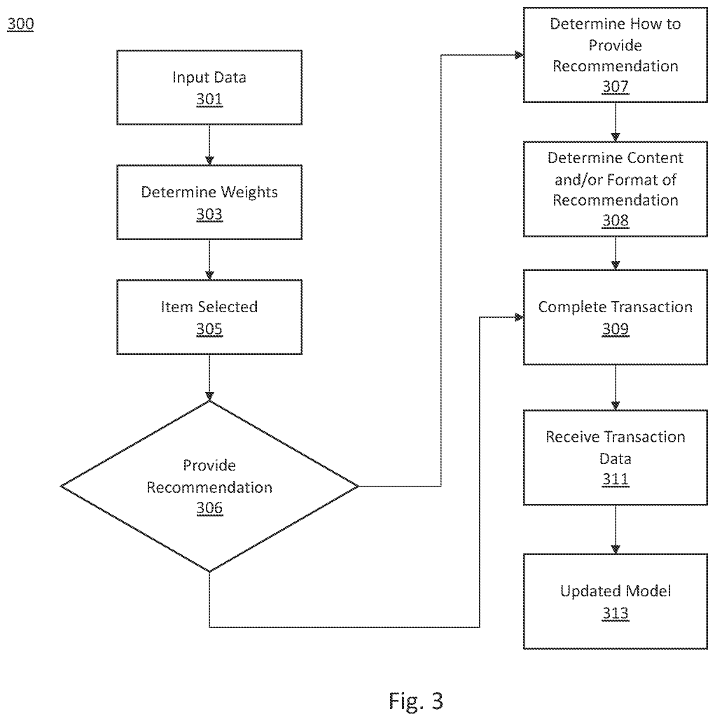

Referring to FIG. 3, an exemplary process 300 for calculating and using weights Wᵢⱼ is now described for illustrative purposes. In step 301, data relating to one or more items 201(k) are input into recommendation engine module 110. In step 303, initial weights Wᵢⱼ are determined for items 201(k). In one example, an item 201(k+1) may be input into an existing model 204 that encompasses items 201(k). In such an example, if there is pre-existing data (e.g. sales data) relating to item 201(k+1) relative to items 201(k), then the weights for item 201(k+1) relative to items 201(k) may be calculated based on such data. If no pre-existing data exists, then weights W may be set to a pre-existing value. In another example, a plurality of items 201(k) may be input into recommendation engine module 110 and there may not be an existing model 204. In such a case, an initial model 204 may be calculated. If there is pre-existing data (e.g. sales data) for some or all of the items 201(k), then the weights W may be calculated for the items relative to each other. If there is no pre-existing data, then the weights W may be set to predetermined values. In one example, the predetermined values may be zero and recommendation engine module 110 may wait a predetermined period of time to allow sales data to accumulate such that weights W may be calculated.

In step 305 an item 201(i) is selected. In step 306, recommendation engine module 110 determines whether or not to provide one or more recommendations based on the selection of item 201(i). In one example, recommendation engine module 110 may decide that any items with weights W greater than a certain threshold will be recommended to user 108. In another example, recommendation engine module 110 may use multiple criteria to determine whether or not to issue a recommendation. For example, recommendation engine module 110 may elect to base issuance of recommendations on volume of recommendations and weights W. For instance, recommendation engine module 110 may determine to recommend the top x number of items 201(k) having weights W above a certain level. In one embodiment, recommendations may be chained together. For example, if item 201(2) is recommended to user 108 based on selection of item 201(1) and there is a W₂₃ sufficiently high to indicated that item 201(3) may be selected if product 201(2), then recommendation engine module 110 may elect to recommend item 201(2) and 201(3) based on selection of item 201(1). If, recommendation engine module 110 determines not to provide a recommendation, then flow passes to step 309.

Referring further to FIG. 3, in step 307, if recommendation engine module 110 determines that a recommendation should be provided to user, then recommendation engine module 110 determines, based on the decision criteria used in step 306, how to provide the recommendation to the user 110. For example, if the recommendation engine module 110 determines that an item has a sufficiently high weight W, then recommendation engine module 110 may output the recommendation to user 108 as part of the checkout process. Recommendation engine module 110 may insert the recommendation into the workstream at checkout such that the user would have to accept or reject the recommendation, on the checkout device, before completing the purchase.

In another example, recommendation engine module 110 may elect to perform a soft recommendation. For instance, recommendation engine module 110 may elect, if the weight W indicates that a recommendation should be provided, but it is not sufficiently high to recommend at checkout, then the recommendation may be provided later and on a different device. In one embodiment, recommendation engine module 110 may identify possible devices on which user 108 may receive a recommendation. For example, if user 108 has a mobile device nearby, recommendation engine module 110 may detect the presence of the mobile device, through the use of a technology, such as Bluetooth or a beacon, and send the notification to the mobile device using near field communication technology. In another example, recommendation engine module 110 may determine that the user 108 has purchased items 201(k) or interacted with system 100 over a network, such as the Internet, and recommendation engine module 110 may elect to send a recommendation to user 108 through a technology, such as email or SMS message.

In one embodiment, in step 308, recommendation engine module 110 may determine, based on the criteria used in step 306 and/or step 307, the content and/or format of the recommendation. For instance, recommendation engine module 110 may provide, if the weighting is sufficiently high, a message on the checkout device to immediately add an item to a checkout cart. The message, if selected, may connect a user device 109 to a backend order fulfillment system, which would then allow the item 201(k) to be delivered to the user 108 at checkout or to be mailed to the user 108. In another example, if a recommendation were to be sent to a user's mobile device, recommendation engine module 110 may format a message specifically for user device 109, such as a mobile device or a personal computer. The recommendation be in a message encoded to include embedded information enabling the user 108 to connect to or connecting the user 108 to one or more systems to procure an item 201(k). In one embodiment, the user 108 may have an app automatically downloaded on the user's 108 device to connect to such systems. Such an app may include security or encryption information that allows a user to connect to such system or it may connect user 108 to an authenticator app allowing the user 108 to connect to such systems. In another embodiment, if recommendation engine module 110 determines to send a recommendation to user 108 over a network, the recommendation may be formatted with additional information to as to why the user is receiving information. For instance, recommendation engine module 110 may determine a communication characteristic or technological context in which the user 108 is likely to receive the recommendation and based on the technological context, a generate or format an appropriate recommendation. In one example, this may be determined from the type of device 109 the user 108 uses to interact with system 100. In one example, it may be determined by the communication medium the user 108 uses to interact with system 100. For example, if the user 108 is to receive a recommendation on a mobile device of one type (e.g. a less robust one) at checkout, then a light recommendation may be provided with minimal information so as to avoid bothering user 108 or complicating checkout. If the user 108 is to receive a recommendation at a later time on a robust device, then the recommendation may be more robust and contain embedded information allowing the user to connect to a system to complete a transaction related to the recommendation. In one embodiment, the embedded information may include authentication information, such as encryption keys or passwords, allowing the user to connect to such systems.

In essence, recommendation engine module 110 surveys the technological environment that the user 109 brings to a transaction and sends recommendations to user 108 that are optimized for the technological environment. If the user 109 interacts with a mobile device, then the recommendation engine module 110 note it. If the user 109 has interacted with the system 100 with a tablet previously, then the recommendation engine module 110 notes it. Recommendation engine module 110 can then analyze the user's 109 technological environment, and correlate the environment with the weights Wᵢⱼ for certain recommendations. Then, based on the weight and the technological environment, the recommendation engine module 110 will determine the most efficient way to communicate the recommendations to a user. For instance, if a weight is high then the recommendation engine module 110 may elect to communicate with the recommendation to a user using all available means (e.g. Bluetooth, email). In another example, if the weight is low, then recommendation engine module 110 may elect to communicate using only one means (e.g. email). In another example, based on the means it elects to communicate, recommendation engine module 110 may choose the most efficient way to encode the message. For instance, if recommendation engine module 110 determines to use near field communication, a communication link may be encoded or embedded in the message sent to user device 109, which allows the user device to connect to system 100, such that it can immediately perform a transaction to purchase an item 201(k). If recommendation engine module 110 determines to send recommendation through email, then information may be encoded in the recommendation that allows a user to connect to system 100 over the internet. In one example, if the weight Wᵢⱼ for a recommendation is low, but high enough to still send a recommendation, recommendation engine 110 may elect to send a recommendation without encoding communication links in the message so as to not upset or irritate the user 108 for a recommendation that the user may only have a limited amount of interest in accepting. Accordingly, system provides a faster and more efficient way of providing recommendations to a user 108.

In step 309, a transaction is completed. In one example, this means the user 108 makes final selections and checks out. In step 311, the recommendation engine module 110 receives data informing recommendation engine module 110 of user's 108 selections. In step 313, recommendation engine module 110 updates model 203 by calculating one or more new weights W based on the user's 108 selections. For example, if the user purchased item 201(1), was recommended item 201(2), and purchased item 201(2), then W₁₂ would be updated accordingly. W₂₁ may also be updated, but differently. For example, in the preceding transaction, W₁₂ and W₂₁ may both receive an increase, but W₂₁ may receive a greater weighing increase given that the recommendation of item 201(2) resulted from selection of item 201(1) whereas item 201(1) was purchased with item 201(2), but not as a result of a recommendation.

FIG. 4 is a block diagram representing a system in which aspects of the methods and systems disclosed herein and/or portions thereof may be incorporated. As shown, the exemplary general purpose computing system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide nonvolatile storage of computer readable instructions, data structures, program modules and other data for the computer 920. As described herein, computer-readable media is a tangible, physical, and concrete article of manufacture and thus not a signal per se.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), cloud implemented memory, and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 4 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 4. The logical connections depicted in FIG. 4 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used, such as Bluetooth and Wi-Fi.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method, comprising:
receiving input indicating that an entity has selected a first item;
utilizing a nodal model to determine a weighted likelihood that the entity may have interest in a second item based on the entity selecting the first item;
employing the weighted likelihood and a communication characteristic of the entity to select a format for providing a recommendation to the entity for purchase of the second item;
encoding the recommendation within a message in the format, which was selected; and
transmitting the message to the entity.

2. The method of claim 1, wherein the input is received from a customer facing checkout system.

3. The method of claim 2, wherein the customer facing checkout system is an on-site checkout kiosk.

4. The method of claim 1, wherein the input is received over a network from a user device.

5. The method of claim 1, wherein the nodal model comprises:
a plurality of nodes, wherein a first node represents the first item, and a second node comprises the second node; and
a plurality of edges connecting the plurality of nodes, wherein a first edge comprises the likelihood the entity would purchase the second item given selection of the first item and a second edge comprises the likelihood the entity would purchase the first item given selection of the second item.

6. The method of claim 1, wherein employing comprises determining the format based on the entity being likely to accept the recommendation and the communication characteristic is a type of device that the entity has for receiving the recommendation.

7. The method of claim 6, wherein encoding comprises embedding a link within the message that allows access to a system for fulfillment of a purchase corresponding to the recommendation.

8. The method of claim 7, wherein transmitting comprises sending the message to the entity through an output device of a kiosk checkout system.

9. The method of claim 7, wherein transmitting comprises sending the message over a network to a user device of the entity.

10. A system, comprising:
a memory; and
at least one module stored in the memory and configured to:
receive input indicating that an entity has selected a first item for purchase;
utilize a nodal model to determine a weighted likelihood that the entity may purchase a second item based on the entity selecting the first item;
employ the weighted likelihood and communication characteristic of the entity to select a format for providing a recommendation to the entity for purchase of the second item;
encode the recommendation within a message in the format, which was selected; and
transmit the message to the entity.

11. The system of claim 10, wherein the input is received from a customer facing checkout system.

12. The system of claim 11, wherein the customer facing checkout system is an on-site checkout kiosk.

13. The system of claim 10, wherein the input is received over a network from a user device.

14. The method of claim 10, wherein the nodal model comprises:
a plurality of nodes, wherein a first node represents the first item, and a second node comprises the second node; and
a plurality of edges connecting the plurality of nodes, wherein a first edge comprises the likelihood the entity would purchase the second item given selection of the first item and a second edge comprises the likelihood the entity would purchase the first item given selection of the second item.

15. The system of claim 10, wherein the at least one module is configured to determine the format based on the entity being likely to accept the recommendation and the communication characteristic a type of device that the entity has for receiving the recommendation.

16. The system of claim 15, wherein the at least one module is configured to embed a link within the message that allows access to a system for fulfillment of a purchase corresponding to the recommendation.

17. The system of claim 16, wherein transmitting comprises sending the message to the entity through an output device of a kiosk checkout system.

18. The system of claim 16, wherein transmitting comprises sending the message over a network to a user device of the entity.

19. A method, comprising:
building a nodal model that includes plurality of nodes and edges, wherein the nodes each represent an item, and the edges each represent the likelihood that an entity may select a second item based on the entity selecting a first item;
receiving input from an entity indicating selection of the first item;
identifying a communication device to send a message to the entity that contains a recommendation for selecting the second item;
encoding the recommendation within a message that is optimized for the communication device; and
transmitting the message to the entity.

20. The method of claim 19, wherein the message includes a link that connects the entity to a system operable to allow the entity to purchase the second item.
